(19) United States
(12) Patent Application Publication
(10) Pub. No.: US 2006/0256728 A1
(43) Pub. Date: Nov. 16, 2006

(54) Method and network-side faciluty for determning a patti in a radio communications system

(76) Inventors: Hui Li, Beijing (DE); Egon Schulz, Munich (DE); Gerhard Stortz, Poing (DE); Dan Yu, Munich (DE)

Correspondence Address: STAAS & HALSEY LLP, SUITE 700, 1201 NEW YORK AVENUE, N.W., WASHINGTON, DC, 20005, US

(21) Appl. No.: 10/548,796

(22) PCT Filed: Feb. 4, 2004
(86) PCT No.: PCT/EP04/01063

§ 371 Date: Jun. 29, 2006

(30) Foreign Application Priority Data
Mar. 11, 2003 (EP) 03005547.9

(51) Int. Cl. H04J 3/14; H04Q 7/00

(52) U.S. Cl. 370/248; 370/328

(57) ABSTRACT

A method determines a path in a radio communications system comprising a multitude of at least partially mobile radio stations of which one radio station that is located in a radio coverage area of another radio station constitutes a radio station that is adjacent to the other radio station. In the radio communications system, items of information can be transmitted by a first radio station, which serves as a transmitting radio station, to a second radio station, which serves as a receiving radio station, over at least one path directly or via one or more other radio stations that receive and relay the items of information. A path between the first and the second radio station consists of a succession of radio stations that, in addition to the first radio station and the second radio station, optionally include the radio stations, which are located in the succession between the first and second radio stations and which receive and relay the items of information. In order to determine at least one path between the first and the second radio station, both the first as well as the second radio station each send a message containing identification information from the respective other radio station to their respective adjacent radio station(s).

### CROSS REFERENCE TO RELATED APPLICATIONS

This application is based on and hereby claims priority to International Application No. PCT/EP2004/001063 filed on Feb. 4, 2004 and German Application No. 0300547.9 filed on Mar. 11, 2003, the contents of which are hereby incorporated by reference.

### BACKGROUND OF THE INVENTION

The invention relates to a method for determining a path in a radio communications system and a network-side facility in a radio communications system comprising a multitude of at least partially mobile radio stations.

In radio communications systems, information (for example, control signals or user data such as voice, images, short messages or other data) is transmitted electromagnetic waves via a radio interface between transmitting and receiving station.

Radio communications systems are often fashioned as cellular systems e.g. in conformance with the GSM (Global System for Mobile Communication) or UMTS (Universal Mobile Telecommunications System) standard with a network infrastructure including base stations, facilities for monitoring and controlling the base stations and further network-side facilities.

In an ad-hoc type of a radio communications system (in this case also called a self-organizing network), radio stations are capable of establishing a radio connection among themselves without a centralized switching facility. The connection between two radio stations is effected either directly or, where greater distances are involved, via further radio stations, which form relay stations for this connection. User information is consequently sent from radio station to radio station over distances that correspond to the radio range of the radio stations. The radio stations of a self-organizing network can be mobile radio stations (for example, mobile phones of persons or in vehicles) and/or predominantly stationary radio stations (for example, computers, printers, domestic appliances). Examples of self-organizing networks are wireless local area networks (WLANs) such as HiperLAN or IEEE 802.11.

A particular advantage of ad-hoc networks lies in their great mobility and flexibility. These factors also represent, however, a major challenge for routing methods. In order to transmit items of information from a transmitter to a receiver in a radio communications system including a plurality of radio stations, a path has to be determined from the transmitter optionally via a plurality of radio stations that relay the data packet to the receiver. This determination requires the transmission of a multitude of signaling information items so that the demand for radio resources to determine a path is under certain circumstances undesirably high. The selection of a path through a radio communications system is designated routing. If the radio stations concerned are mobile radio stations, then as a rule the topology of the network changes over time.

### SUMMARY OF THE INVENTION

One possible object of the invention is to reveal a method and a network-side facility of the type specified in the introduction that permit resource-saving determination of a path in a radio communications system comprising a multitude of at least partially mobile radio stations.

The radio communications system comprises a multitude of at least partially mobile radio stations. A radio station that is located in a radio coverage area of another radio station is designated an adjacent radio station to the other radio station. In the radio communications system, items of information can be transmitted by a first radio station, which serves as a transmitting radio station, to a second radio station, which serves as a receiving radio station, over at least one path directly or via one or more other radio stations that receive and relay the items of information.

Here, a path between the first and the second radio station includes a succession of radio stations that, in addition to the first radio station and the second radio station, optionally includes the radio stations which are located in the succession between the first and second radio stations and which receive and relay the items of information.

In order to determine at least one path between the first and the second radio station, both the first and the second radio station each send a message containing identification information from the respective other radio station to their respective adjacent radio station(s).

The radio communications system can contain both mobile and stationary radio stations. Examples of mobile radio stations are mobile stations or laptops, examples of stationary radio stations are base stations, radio access points or stationary computers with a radio connection. These radio stations can communicate with one another. It is possible that, in order to communicate with other radio stations, radio stations have different types of radio interfaces with different radio coverage areas. Thus, a mobile station, for example, can have a different radio coverage area for communicating with a base station than for communicating with another mobile station. A radio station is adjacent to another radio station if it is currently located in a radio coverage area of this other radio station. Of relevance for checking whether two radio stations constitute adjacent radio stations is the radio coverage area that relates to the communications between these two radio stations. A mobile station is adjacent to another mobile station, for example, when it is currently located inside a radio coverage area of the other mobile station that is used for communicating with mobile stations. A radio station within the radio communications system under consideration can have a random number of adjacent radio stations.

In the radio communications system, items of information can be transmitted from a first radio station to a second radio station. If these two radio stations are adjacent radio stations, then the transmission of items of information can take place directly. If, however, the two radio stations are not adjacent, then relaying of the information items by other radio stations is necessary. The items of information can then be received and relayed by one or more other radio stations. To this end, the items of information carry an identification information of the second radio station. The relaying is effected as per the explanation above respectively via adjacent radio stations. Relaying is possible both exclusively via radio stations of the same type such as, for example, mobile stations of the same type, and via radio stations of different types, such as, for example, mobile stations and base stations.

The items of information are transmitted in the radio communications system over a path. This path includes firstly of the first radio station that initially emits the items of information, then of the radio station(s) that relay the items of information and lastly of the second radio station that ultimately receives the items of information.

In order to determine a path, the first and the second radio stations emit a message. This message is respectively sent in particular by multi-address calling to all the neighbors of the radio stations emitting this message. In order to be able to determine a path through the radio communications system, the message emitted carries an identification information of the respective other radio station. The message emitted by the first radio station in order to determine at least one path thus carries an identification information from the second radio station, and the message emitted by the second radio station carries an identification information of the first radio station. Advantageously, the sending of these two messages by the first and by the second radio station occurs approximately simultaneously. The messages are emitted by the first and the second radio station without their having received from an adjacent radio station immediately beforehand a similar message to determine a path between the first and the second radio station, the messages do not to this extent include a relaying of messages to determine a path. In particular, neither of the two radio stations has received the message of the respective other radio station before it transmits its own message. Consequently, the two messages initiate at different points in the radio communications system a method for determining the same path or the same paths through the radio communications system. Due to the fact that the message to determine a path is emitted by the first and by the second radio station, this is a bi-directional approach to determining a path.

In a further development, the first and the second radio station are requested to send the respective message by a network-side facility of the radio communications system. This request can be effected via a radio station. In particular, the request can contain the identification information of the respective other radio station. Such a request permits a mixture of a centralized determination, controlled by a network-side facility, of at least one path between the first and the second radio station and a decentralized determination, implemented by individual radio stations, of at least one path between the first and the second radio station.

The first radio station preferably informs the network-side facility prior to the request about a future transmission of items of information from the first to the second radio station. Prior to the request, the first radio station can also request information about at least one path between the first and the second radio station from the network-side facility.

In one embodiment, the adjacent radio station(s) which has/have received the respective message relay(s) the respective message, after adding identification information, to their respective adjacent radio station(s). A radio station which has received a message to determine at least one path between the first and the second radio station can thus add an identification information of its own to this message. After adding this identification information, the corresponding radio station relays the message that has been modified in this way. This method can be used correspondingly in respect of the radio station(s) which subsequently receive(s) the modified message. In this way, a message emerges that comprises a succession of identification information items. This succession of identification information items then corresponds to a path through the radio communications system.

Advantageously, a radio station which has received
both a message optionally comprising identification information, added by one or more radio stations, from the first radio station
and a message optionally comprising identification information, added by one or more radio stations, from the second radio station
   transmits items of information over a path between the first and the second radio station to the first and/or the second radio station optionally via one or more further radio stations using the information about the path. The at least one radio station has thus received two related messages from the first and the second radio station, optionally via other radio stations, which messages serve to determine a path between the first and the second radio station.

The at least one radio station can recognize that the two messages are related from an identification information in the messages and/or from the fact that both messages serve to determine a path between the first and the second radio station. Since these messages comprise the identification information of the radio stations relaying the messages, a path through the radio communications system is known to the at least one radio station. This at least one radio station can then transmit information about this path to the first and/or to the second radio station. The at least one radio station can use its knowledge of the path for this transmission. Consequently, the information about the path between the first and the second radio station is transmitted on one or more parts of the path between the first and the second radio station. In this way, the first and/or the second radio station can acquire knowledge about the path between the first and the second radio station that has been determined in this manner. This path can then be sent in order to send information from the first to the second radio station. To this end, the path can be inserted in a header of the information to be transmitted.

According to one embodiment, the at least one path to be determined between the first and the second radio station constitutes
a part of an entire path between the first radio station, which serves as a transmitting radio station, and the second radio station, which serves as a receiving radio station, or
a part of an entire path between a radio station other than the first radio station, which serves as a transmitting radio station, and the second radio station, which serves as a receiving radio station, or
a part of an entire path between a radio station other than the first and the second radio station and a further radio station other than the first and the second radio station.

Consequently, the method can be used simultaneously by a plurality of pairs of radio stations, and consequently, an entire path can be determined which is composed of a plurality of individual paths. This procedure corresponds to a multidirectional method for determining a path, since the method can in this case be initiated approximately simultaneously from more than two points in the radio communications system.

The aforementioned object is achieved with regard to the network-side facility in a radio communications system in a network-side facility comprising the features of claim 7.

One embodiment is the subject matter of a dependent claim.

The network-side facility may comprise a selector to select at least two radio stations from at least one path between the first and the second radio station, which are requested to send respectively one message to determine the at least one path.

The request to the at least two radio stations can be implemented directly by the network-side facility, or else at the request of the network-side facility also by other radio stations. The path to be determined is not known to the network-side facility when the at least two radio stations are selected. Rather, the network-side facility stipulates, through the selection of at least two radio stations, points of the path to be determined in the shape of the selected radio station. This selection of the at least two radio stations can be effected using different criteria. Examples of criteria are a location-dependency of the selected radio stations: thus, for example, preferably radio stations in the center or at the edge of the geographical area or of a radio cell can be sought, or else at least one radio station from any radio cell through which the path specifically to be determined is to run. Further examples are the signal strength of radio signals from radio stations or else a random mechanism for selecting radio stations.

The network-side facility can, for example, be a base station or a facility connected to one or more base stations.

In one embodiment, the network-side facility comprises a memory to store neighborhood relations between the radio stations of the radio communications system. This can, for example, be a table in which the current adjacent radio stations are listed for each radio station in the radio communications system. The network facility is particularly suitable for implementing the method. Further devices implementing the method can be provided in the network-side facility.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a part of a radio communications system,

FIG. 2 shows a first flow diagram of a method according to one embodiment of the invention,

FIG. 3 shows a schematic illustration of a sequence of a method according to one embodiment of the invention in a radio communications system,

FIG. 4 shows a second flow diagram of a method according to one embodiment of the invention,

FIG. 5a shows a first pictorial representation of an advantage of the method according to one embodiment of the invention,

FIG. 5b shows a second pictorial representation of an advantage of the method according to one embodiment of the invention.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

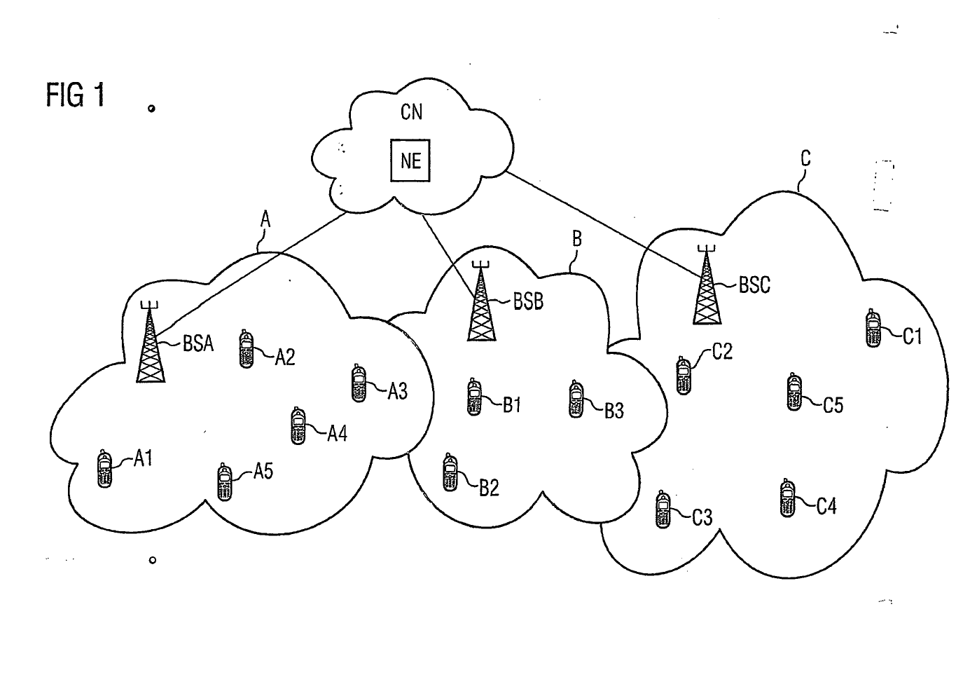

FIG. 1 shows a section from a radio communications system. This comprises three base stations BSA, BSB and BSC. Also present in the radio communications system are the subscriber-side radio stations A1, A2, A3, A4, A5, B1, B2, B3, C1, C2, C3, C4 and C5. The radio stations A1, A2, A3, A4 and A5 are located in the radio cell A of the base station BSA. Correspondingly, the radio stations B1, B2 and B3 are currently in the radio cell B of the base station BSB and the radio stations C1, C2, C3, C4 and C5 in the radio cell C of the base station BSC. The core network CN contains a network-side facility NE and is connected to the base stations BSA, BSB and BSC.

The case whereby the radio station Al wants to send items of information to the radio station C1 is examined below as an example. The radio communications system under consideration is a mixture of a cellular radio communications system and a wireless local area network (WLAN). This mixed character of the radio communications system under consideration is expressed in the fact that on the one hand, in order for data to be transmitted between the individual radio stations, this data is relayed from radio station to radio station, and in that on the other hand the core network or the base stations are needed for certain functions. In order to transmit the items of information from the radio station A1 to the radio station C1, these items of information are relayed over a path from radio station to radio station. A radio station can relay items of information respectively to another radio station in its radio coverage area. Radio stations which are located in their respective radio coverage areas are adjacent radio cells.

The radio stations A1, A2, A3, A4, A5, B1, B2, B3, C1, C2, C3, C4 and C5 have respectively a similar first radio range which is significantly smaller than the radio range of the base stations BSA, BSB and BSC. The radio range of the base stations BSA, BSB and BSC corresponds to at least the radius of the radio cells A, B and C. Besides the first radio range, the radio stations A1, A2, A3, A4, A5, B1, B2, B3, C1, C2, C3, C4 and C5 additionally have a larger second radio range, on the basis of which they can communicate with the base stations BSA, BSB and BSC. Consequently, the radio stations A1, A2, A3, A4, A5, B1, B2, B3, C1, C2, C3, C4 and C5 have two radio ranges available, the first being used for communication between the radio stations A1, A2, A3, A4, A5, B1, B2, B3, C1, C2, C3, C4 and C5 and the second for communication with the base stations BSA, BSB and BSC.

The radio station A1 now intends to send items of information via other radio stations to the radio station C1. For this purpose, a path through the radio communications network must be known to the radio station A1. In the example under consideration, a path could, for example, include the following succession of radio stations: A1, A2, A3, B1, B3, C2, C5 and C1. The said radio stations A1, A2, A3, B1, B3, C2, C5 and C1 are respectively adjacent pairs, so that they can receive and forward the items of information. In order for the items of information which the radio station A1 sends to be switched onward over the path known to it to the radio station C1, information about this path is contained in a header of the items of information. A radio station receiving the items of information recognizes from the details about the path that it is to relay the items of information along the path. This procedure continues until the radio station C1 recognizes from the path or from another item of information about the addressee of the items of information that it is the ultimate recipient of the items of information which evaluates and does not forward the items of information.

The radio station A1 can firstly check in a memory connected to it whether it knows a path to the radio station C1. Such a storing of paths by the radio communications system is particularly helpful if the radio communications system comprises a multitude of stationary, i.e. non-mobile, radio stations. By these are meant, for example, base stations which can also be used for relaying items of information. If, in contrast, the radio communications system has a multitude of mobile radio stations, then the positions of these radio stations change as a rule over time so that after a certain period paths can cease to be up to date. In this case, the use of stored path tables can be dispensed with, or the paths of the tables are automatically deleted after a period to be defined and thus no longer used without checking.

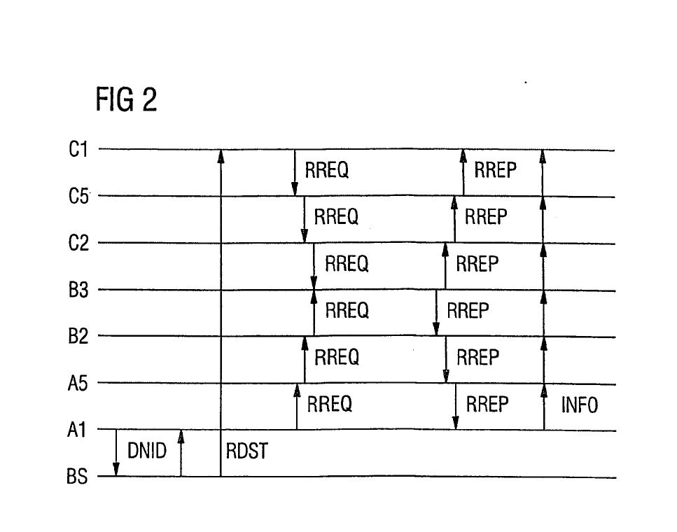

In the example looked at, it is assumed that the radio station A1 does not know a path to the radio station C1. FIG. 2 shows a method according to one embodiment of the invention for determining a suitable path through the radio communications system shown in FIG. 1. Initially, the radio station A1 sends a DNID (destination node identification) message to the base station BSA. The DNID notification contains a request to the base station BSA or the core network CN to check whether the radio station C1 is registered in the radio communications system. This check can take place in the core network CN using various tables or registers, such as e.g. an HLR (home location register) or a VLR (visitor location register). If the core network CN ascertains that the desired radio station C1 is currently not available in the radio communications system as a receiver of items of information, then the base station BSA sends a corresponding error message to the radio station A1. In the example under consideration, it is determined by the core network CN that the radio station C1 is located in the radio cell C of the base station BSC.

The base station BSA then sends an RDST (route discovery start) message to the radio station A1, by which the radio station A1 is requested to initiate, by emitting a suitable broadcast message, the method for determining the path to the radio station C1. The base station BSC also sends a corresponding RDST message to the radio station C1. Via this RDST message, the radio station C1 is requested likewise to initiate, by emitting a suitable broadcast message, the method for determining a suitable path between the radio station C1 and the radio station A1. While the endpoint of the sought path in the shape of the radio station C1 is already known to the radio station A1 due to its DNID request, an identification information of the radio station A1, which for the radio station C1 constitutes the endpoint of the path to be determined, is communicated to the radio station C1 by the RDST message from the base station BSC.

The radio station A1 then emits an RREQ (route request) message. This RREQ message is broadcast so that all the radio stations adjacent to the radio station A1 are addressed by this RREQ message. The RREQ message which is emitted by the radio station A1 contains information about the fact that a path is sought between the radio station A1 and the radio station C1. A similar RREQ message is also emitted by the radio station C1, this message informing the radio stations that a path is to be determined between the radio station C1 and the radio station A1.

An RREQ message can contain an identification number of the path determination, information about a maximum number of radio stations which the path to be determined may contain and a field which displays the number of relays of the RREQ message, as well as an identification information of the first and of the second radio station.

All radio stations which receive a corresponding RREQ message take from the message the request to relay this RREQ message by broadcasting. Before relaying the RREQ message, an identification information of the radio station receiving and relaying the RREQ message is appended to the RREQ message. Furthermore, before relaying the RREQ message, the radio station increases by one the value of the field containing the number of relays. If the number of relays reaches the maximum number of radio stations which the path to be determined may contain—less the first and the second radio station—then the radio station discards the RREQ message and does not relay it onward.

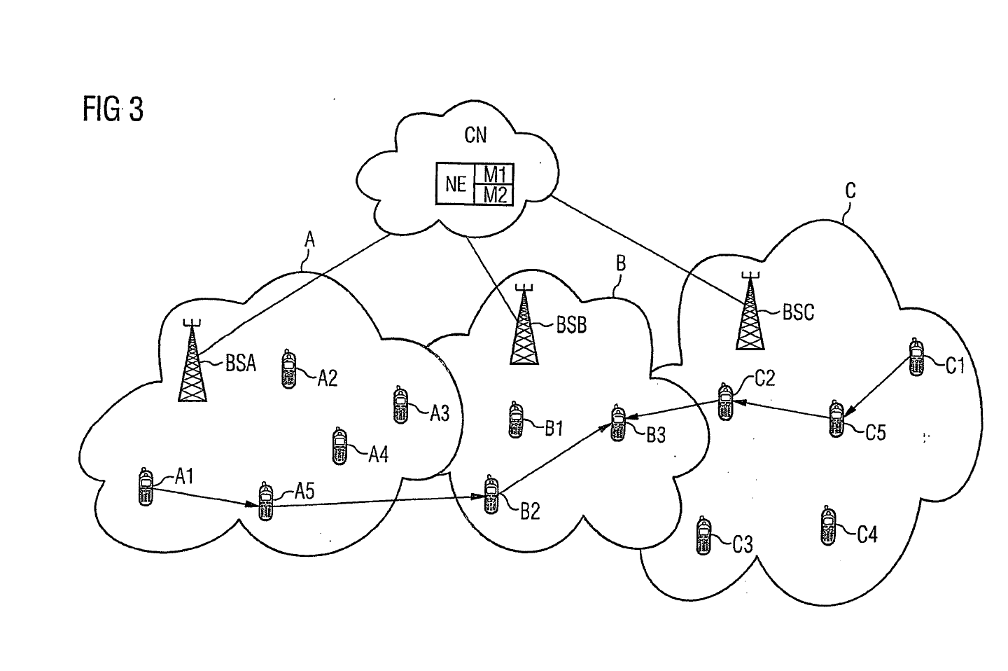

It can be seen in FIG. 3 that the radio station A5 is located adjacent to the radio station A1. Consequently, the radio station A5 receives the RREQ message of the radio station A1. After receiving the RREQ message, the radio station A5 appends its identification information to the RREQ message and emits the thus modified RREQ message via broadcast. The radio station A1 subsequently receives, due to its location adjacent to the radio station A5, the RREQ message which is emitted by the radio station A5. It recognizes, however, from the RREQ message that it has itself already sent this message, and consequently does not relay the RREQ message further again. Each radio station which receives an RREQ message also checks whether it has stored the sought path through the radio communications system in a memory. If, for example, the radio station A5 were to recognize that it knows a path between the radio station A1 and the radio station C1, then it would not emit an RREQ message but send a message containing the sought path to the radio station A1.

Correspondingly, the radio station C5 also receives an RREQ message from the radio station C1 which shows it that a path is being determined between the radio station C1 and the radio station A1. The radio station C5 checks to ascertain whether such a path is known to it, possibly from a memory. If this is not the case, then it broadcasts an RREQ message after it has attached its identification information to this message.

The general procedure for determining a path is accordingly the following: the two radio stations A1 and C1 initiate the method by respectively broadcasting an RREQ message. This RREQ message contains the message that a path is sought between the radio stations A1 and C1. Each radio station adjacent to these two radio stations A1 and C1 that receives the RREQ message checks whether such a path is known to it. Such a check can, in the case of mobile radio communications systems, also be omitted. Furthermore each radio station which has received an RREQ message checks, optionally using an identification number of the determination of the path, whether it has already received this message at an earlier point in time. If this is the case, then this radio station does not respond to the RREQ message. However, if a radio station has not received such an RREQ message at an earlier point in time, then it appends its identification information to the RREQ message and also broadcasts the thus modified RREQ message. Furthermore, where a maximum number of radio stations per path is used, the corresponding counter can also be increased by the radio station.

Since the RREQ message was sent both by the radio station A1 and by the radio station C1, radio stations are reached both by RREQ messages from the radio station A1 by which a path between the radio station A1 and the radio station C1 is sought and by RREQ messages from the radio station C1 by which a path between the radio station C1 and the radio station A1 is sought. FIG. 3 shows the case whereby this situation firstly applies to the radio station B3. The radio station B3 has thus received an RREQ message from the radio station B2 from which it recognizes that a path is sought between the radio station A1 and the radio station C1, as well as an RREQ message from the radio station C2 from which it can be seen that a path is sought between the radio station C1 and the radio station A1. From the contents of these two RREQ messages, the radio station B3 recognizes that these two RREQ messages refer to the same path to be determined. The RREQ message from the radio station B2 contains identification information about the radio stations A1, A5 and B2. The RREQ message from the radio station C2 correspondingly contains identification information about the radio stations C1, C5 and C2. Consequently, after receiving the two RREQ messages, a path between the radio stations A1 and C1 is known to the radio station B3. As can be seen in FIG. 2, the radio station B3 then transmits an RREP (route reply) message to the radio stations C2 and B2. These RREP messages are not broadcast, but sent using a single-address call. For this purpose, the radio station B3 uses the knowledge of the path between the radio stations A1 and C1. The RREP messages contain information about the path between the radio stations A1 and C1. This information is relayed by the radio stations in accordance with the succession of the path between the radio stations A1 and C1 as far as the transmitting radio station A1 and as far as the receiving radio station C1. Here, the path to be used for relaying can be inserted in a header of the RREP messages. The radio station B2 then recognizes, for example, that the identification information of the radio station A5 follows its identification information, so that it transmits an RREP message to the radio station A5.

The information about the path between the radio station A1 and the radio station C1 which the radio station B3 emits using the RREP messages can also be sent back solely to the radio station A1. In this case, the radio station C1, while having initiated the method to determine the path, has no knowledge of the path determined between the radio stations A1 and C1. Since, however, the radio station A1 wants to send items of information INFO to the radio station C1, it suffices if only this radio station C1 knows the path determined between the radio stations A1 and C1. It is also possible that the information about the path that the radio station B3 emits by the RREP messages relates to only a part of the path. Thus, the radio station B3 can transmit only the partial path between the radio station A1 and the radio station B3 to the radio station A1. In order to send the items of information INFO from the radio station A1 to the radio station C1, the radio station A1 then transmits firstly over the partial path known to it, whereupon the radio station B3 inserts the appropriate partial path for the second part of the path between the radio station B3 and the radio station C1 into the header of the information.

As a rule, a plurality of paths through the radio communications system are determined using the method. The result is that a plurality of paths are available to the radio station A1 for sending the items of information INFO to the radio station C1. The radio station A1 can then make an appropriate selection from these paths in order to send the items of information to the radio station C1, or it can use a plurality of paths to send the items of information INFO to the radio station C1.

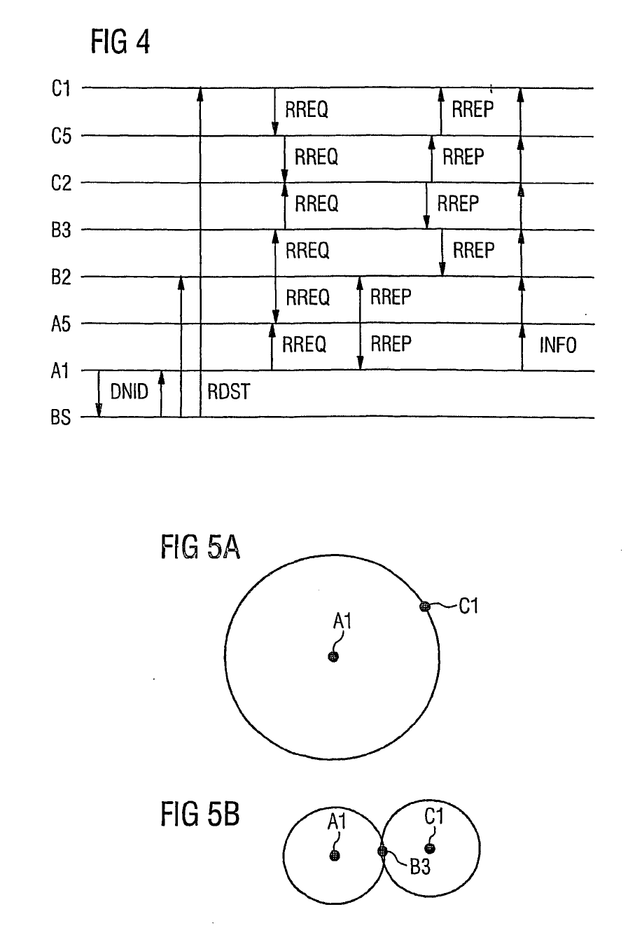

In the method described thus far, the two radio stations A1 and C1, which initiate the method for determining the path by sending an RREQ message, are the radio station that initially transmits the information and the radio station that ultimately receives the information. The path between these two radio stations is consequently the entire path over which the items of information are to be sent. It is, however, also possible for the path to be determined to constitute only a part of an entire path over which items of information are to be sent. This can be achieved through the network-side facility instructing a plurality of radio stations to emit a corresponding RREQ message to determine a path through the radio communications system. FIG. 4 shows the case in which the network-side facility NE from FIG. 1 transmits, after receiving a DNID message from the radio station A1, an RDST message to the radio stations A1, B2 and C1. This transmission is effected for the radio station A1 using the base station BSA, for the radio station B2 using the base station BSB and for the radio station C1 using the base station BSC. In the RDST messages, the radio stations addressed are requested to broadcast RREQ messages to determine a path through the radio communications system. The RDST message to the radio station A1 contains the instruction to determine a path between the radio station A1 and the radio station B2. The RDST instruction to the radio station B2 contains the instruction to determine both a path between the radio station B2 and the radio station A1 and a path between the radio station B2 and the radio station C1. Correspondingly, the RDST message to the radio station C1 contains the instruction to determine a path between the radio station C1 and the radio station B2. These respective items of information must then be enclosed by the radio stations A1, B2 and C1 with the RREQ messages emitted by them.

The radio stations A1, B2 and C1 are selected by the network-side facility NE using device M1 for selecting radio stations. To this end, it is advantageous for the network-side facility NE to know the current topology, i.e. the neighborhood relations between the various radio stations. A method for determining the topology of the network can, for example, appear as follows: each radio station transmits at regular time intervals a broadcast signal in which it requests the respective adjacent radio stations to send a reply. After such a reply has been received from its adjacent radio station(s), it is known to the corresponding radio station which radio stations are currently located in its neighborhood. The radio station then sends these items of information via the corresponding base station to the network-side facility NE. If all the radio stations of the radio communications system implement such a method for determining the current topology of the network, then the overall topology of the network is known to the network-side facility NE. Advantageously, the method is carried out several times, e.g. at periodically recurring times, so as to take the mobility and availability of radio stations into account. This topology can be stored in the network-side facility NE using memory M2 for storing neighborhood relations.

It can be seen in FIG. 4 that the radio stations A1, B2 and C1 each emit, after receiving the RDST message, an RREQ message to determine the appropriate path. The method for determining the partial paths between the radio stations A1 and B2, and between the radio stations B2 and C1, proceeds analogously to the above described determination of the path between the radio stations A1 and B1. According to FIG. 4, the radio station A5 has received a message to determine the path between the radio stations A1 and B2 both from the radio station A1 and from the radio station B2. It then sends a corresponding RREP notification containing information about the determined path to the radio stations A1 and B2. In respect of this transmission of information about the path by the RREP message, the description with regard to this RREP signal as per the above version applies accordingly. The radio station C2 has also received both a signal from the radio station C1 to determine a path between the radio stations C1 and B2 and an RREQ message from the radio station B2 to determine a path between the radio stations B2 and C1. Using the knowledge of this path, it then sends information about the path determined between the radio stations B2 and C1 of single-address calling via the radio stations C5 and B3 back to the radio stations B2 and C1. Furthermore, the radio station B2 can relay this information over the path to the radio station A1. The transmission of information from the radio station A1 to the radio station C1 is, however, also possible without this relaying of the part of the path to the radio station A1.

Finally, knowing the path, the radio station A1 can transmit the items of information INFO via the radio stations A5, B2, B3, C2 and C5 to the radio station C1. It is also possible in the case of this procedure for a plurality of paths to be determined between the radio station A1 and the radio station C1. Each of these paths contains, however, the radio station B2. This fact proves to be problematic, however, when the radio station B2 for forwarding the items of information INFO fails. In order to reduce such a risk of failure, the network-side facility NE can request a plurality of radio stations between the transmitting radio station A1 and the receiving radio station C1 to emit an RREQ message to determine a path. Thus, for example, an RDST message containing the request to emit an RREQ message could go not only to the radio stations A1, B2 and C1 but also to the radio station B1. The radio station B1 would then be instructed by the RDST message to determine a path between the radio station B1 and the radio station A1 and to determine a path between the radio station B1 and radio station C1. Furthermore, the radio station A1 would be instructed by the RDST message to determine a path between the radio station A1 and the radio station B2, as well as a path between the radio station A1 and the radio station B1. Correspondingly, the radio station C1 would be requested to determine a path between the radio station C1 and the radio station B2, as well as a path between the radio station C1 and the radio station B1. In this case, at least two paths through the radio communications network would thus be determined, at least one path containing the radio station B2 and at least one further path containing the radio station B1.

It is also possible for a base station to be requested by the network-side facility to send a message to determine a partial path. In this case, the base station concerned can send the information about partial paths transmitted to it to the network-side facility. This network-side facility can transmit the information concerned to the radio station A1 via the base station BSA or use this information exclusively for updating availabilities of radio stations within the radio communications system that are stored in the network-side facility.

The described method has the advantage that the number of signaling messages for determining a path through the radio communications system can be reduced significantly compared with known non-bi-directional methods. This is illustrated schematically in FIGS. 5a and 5b. If solely the radio station A1 were to begin broadcasting messages to determine a path to the radio station C1, then the circle shown in FIG. 5a represents the area of the radio communications system within which messages would have to be broadcast by radio stations in the radio communications system in order to determine a path. If, on the other hand, both the radio station A1 and the radio station C1 emit in accordance with the method such a message to determine a path through the radio communications system, then the area of the two circles in FIG. 5b shows the areas of the radio communications system within which corresponding messages to determine a path have to be emitted by the radio stations. It can be seen by comparing FIGS. 5a and 5b that the number of signaling messages is significantly reduced by a bi-directional procedure for determining a path through the radio communications system.

A further advantage can be seen in the fact that the path between the transmitting radio station and the receiving radio station can be found more rapidly using the method than with known methods for determining a path. The result is that the connection between the transmitting and the receiving radio station can be established within a shorter time span.

The method can be used for a wide variety of sizes of radio communications systems, so scalability is available. The method can be used within a single radio cell or also, as shown in FIG. 3, for a plurality of radio cells. The larger the radio communications system under consideration is, and the further the spatial distance between the transmitting and the receiving radio station becomes, the more radio stations should receive an instruction from the network-side facility to initiate a method for determining a path through the radio communications system through the emission of suitable messages.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-8. (canceled)

9. A method for determining a path for information to be transmitted in a radio communications system comprising a plurality of mobile radio stations, with adjacent radio stations being located in radio coverage areas of one another, the information being transmitted in succession from a transmitting radio station to a receiving radio station by relaying the information via adjacent intermediate radio stations, the method comprising:
sending a first message from the transmitting radio station to radio stations adjacent thereto, the first message identifying the receiving radio station; and
sending a second message from the receiving radio station to radio stations adjacent thereto, the second message identifying the transmitting radio station, the receiving radio station sending the second message before receiving the first message.

10. The method according to claim 9, wherein
the transmitting and receiving radio stations are requested to respectively send the first and second messages by a network-side facility of the radio communications system.

11. The method according to claim 10, wherein
prior to the network-side facility requesting the first and second messages, the transmitting radio station:
informs the network-side facility about a future transmission of information from the transmitting radio station to the receiving radio station
or
requests information from the network-side facility about a path between the transmitting and receiving radio stations.

12. The method according to claim 9, wherein
when an intermediate radio station receives the first or second message, the intermediate radio station adds self-identification information to the message before relaying the message.

13. The method according to claim 9, wherein when an intermediate radio station receives both the first and second messages, the intermediate radio station transmits information about a path between the transmitting and receiving radio stations, to the transmitting and/or the receiving radio station, using the information about the path.

14. The method according to claim 9, wherein the path to be determined is a partial path constituting:
a path between the transmitting radio station and a radio station other than the receiving radio station, or
a path between a radio station other than the transmitting radio station, and the receiving radio station, or
a path between two intermediate radio stations, neither of which is the transmitting radio station or the receiving radio station.

15. The method according to claim 9, wherein the radio communications system is formed from mobile radio stations and stationary stations.

16. The method according to claim 9, wherein the first message is sent by a radio station other than a radio station which originated the information and/or the second message is sent by a radio station other than a radio station which is a final destination for the information.

17. The method according to claim 11, wherein
when an intermediate radio station receives the first or second message, the intermediate radio station adds self-identification information to the message before relaying the message.

18. The method according to claim 18, wherein when an intermediate radio station receives both the first and second messages, the intermediate radio station transmits information about a path between the transmitting and receiving radio stations, to the transmitting and/or the receiving radio station, using the information about the path.

19. The method according to claim 19, wherein the path to be determined is a partial path constituting:
a path between the transmitting radio station and a radio station other than the receiving radio station, or
a path between a radio station other than the transmitting radio station, and the receiving radio station, or
a path between two intermediate radio stations, neither of which is the transmitting radio station or the receiving radio station.

20. A network-side facility in a radio communications system comprising a plurality of mobile radio stations, with adjacent radio stations being located in radio coverage areas of one another, wherein
the network-side facility assists in determining a path for information to be transmitted in succession from a transmitting radio station to a receiving radio station by relaying the information via adjacent intermediate radio stations, and
the network-side facility comprises a selector to select at least two radio stations along the path between the transmitting and receiving radio stations, the selected stations being requested to send respectively one message in order to determine the path.

21. The network-side facility according to claim 21, wherein
the network-side facility comprises a memory to store neighborhood relations between the radio stations of the radio communications system.

22. The network-side facility according to claim 21, wherein the selector selects that transmitting and receiving stations.
